(19) United States
(12) Patent Application Publication
(10) Pub. No.: US 2006/0185863 A1
(43) Pub. Date: Aug. 24, 2006

(54) Thistle kicker - an improved plant cultivation tool

(76) Inventor: John M. Solbach III, Lawrence, KS (US)

Correspondence Address: Hudson H. Luce;Attorney-at-Law, 600 Ohio, Lawrence, KS, 66044, US

(21) Appl. No.: 11/352,529

(22) Filed: Feb. 13, 2006

Related U.S. Application Data
(60) Provisional application No. 60/654,688, filed on Feb. 18, 2005.

(51) Int. Cl. A01B 1/00

(52) U.S. Cl. 172/378

(57) ABSTRACT

A plant cultivation tool is disclosed which is especially suited to efficient removal of plants from compacted, rocky, or sandy soils; loosening those soils; and insertion of plants into those soils, without becoming bent or broken in the course of daily use. This tool is simple and has no moving parts, thus care and maintenance requirements are minimal.

### CROSS-REFERENCE TO RELATED APPLICATIONS

The present application claims the benefit of Provisional Application No. 60/654,688 filed on Feb. 18, 2005, which is incorporated herein by reference, and which is not admitted to be prior art with respect to the present invention by its mention in the background.

### STATEMENT REGARDING FEDERALLY SPONSORED RESEARCH OR DEVELOPMENT

Not Applicable

### BACKGROUND

(1) Field of the Invention

This invention relates to agricultural implements which are used to work the ground, and more particularly to a single throw lever designed for ejecting plants from the ground with tap roots intact, for cultivating and breaking compacted and rocky soils, and for placing plants in soil.

(2) Description of Related Art

Musk thistles are a constant problem in agricultural areas, and are often required by law to be removed from farm property. These plants are often found in hard compacted soils which are hard to penetrate, and which may contain rocks, gravel, and clay deposits. In areas where rocks are present in soils, it may be necessary to drive the blade of the tool into the ground with a hammer or with a maul. The great majority of plant extraction tools in existence can not long survive these conditions, becoming bent or broken after relatively little use. It is essential to remove the entire tap root of the plant at the same time the rest of the plant is removed in order to prevent regrowth, and this is difficult, since the tap root may be easily severed, cut, or broken off from the rest of the plant during the removal operation. Tools with sharp cutting blades are especially liable to leave parts of the tap root in the ground.

Before filing this application, the applicant was aware of the following patents:

| | | | |
|---|---|---|---|
| 5,609,325 | March 1997 | DeArmond | 254/132 |
| 4,281,866 | August 1981 | Atcheson | 254/132 |
| 3,976,282 | August 1976 | Baker | 254/132 |
| 3,865,348 | February 1975 | Close | 254/132 |
| 3,288,437 | November 1966 | Pederson | 254/132 |
| 3,273,929 | September 1961 | Shurtz | 254/132 |
| 3,138,365 | June 1964 | Rundle | 254/132 |
| 2,843,359 | July 1958 | Franz | 254/132 |
| 2,716,538 | August 1955 | Arrowood | 254/132 |
| 2,504,746 | April 1950 | Stecker | 254/132 |
| 2,378,459 | June 1945 | Beardsley | 254/132 |
| 2,373,898 | April 1945 | Kulesh | 254/132 |
| 2,247,958 | July 1941 | Maxcy | 254/132 |
| 2,166,015 | July 1939 | Mikkelson | 254/132 |
| 2,121,265 | June 1938 | Ruffcorn | 254/132 |
| 1,908,735 | December 1935 | Donaldson | 254/132 |
| 1,864,373 | December 1935 | Smith | 254/132 |
| 1,857,500 | May 1932 | Davison | 254/132 |
| 1,822,675 | September 1931 | Shelkofsky | 254/132 |
| 1,734,026 | August 1929 | Joseph | 254/132 |
| 1,494,557 | May 1924 | Lumry | 254/132 |
| 1,278,680 | October 1918 | Klaffert | 254/132 |
| 1,131,714 | March 1915 | Kress | 254/132 |
| 1,107,705 | August 1914 | Ruddy | 254/132 |
| 357,907 | February 1887 | Clarke | 254/132 |

In addition, the inventor is aware of the following patent applications:

| | | | |
|---|---|---|---|
| 09/915,389 | March 2002 | Novotny | 254/132 |
| 10/717,724 | November 2003 | Hoover | 254/132 |

Other patents and patent applications do not appear to the inventor to be pertinent or relevant to his invention. Unless otherwise stated, the terms “Patent Number” and “Patent Application” below refer to United States Patent, either issued or applied for, respectively.

Atcheson (U.S. Pat. No. 4,281,866) discloses a weed puller made from a single strap of steel, which is designed to be used in moist soils on plants such as dandelions which have thick breakage-resistant tap roots. Atcheson's tool grabs the tap root and extracts the weed from the ground. Atcheson's tool is not particularly designed for weed removal from compacted or rocky soil where musk thistles predominate, and would probably break off musk thistle and other similar tap roots which are prone to easy breakage.

Joseph (U.S. Pat. No. 1,734,026) discloses a similar tool made from sheet metal, whose working edges are rounded so as not to cut the tap root, but grabs the tap root between the upper and middle ends and would probably break off musk thistle and other noxious weed tap roots which are prone to easy breakage.

Kress (U.S. Pat. No. 1,131,714) discloses a similar tool which suffers from the same problem, being made from a single piece of sheet steel, which is bent to form the tool, and for which no tempering or hardening process is disclosed. The Kress tool could be re-bent by compacted and rocky soils and thus rendered useless in effective removal of musk thistles.

Arrowood's tool (U.S. Pat. No. 2,716,538) appears also to be fashioned from a steel strap, with the flat edge which meets the tap root being sharpened. This tool appears to be designed for lawn and garden work, and its object is to either loosen the soil so that the weed might be removed by hand or to engage the root directly with the blade and remove the weed. In removing musk thistles, the use of this tool could either be inefficient, in the former mode of use, or futile, in the latter mode of use, since the tap root could be broken.

DeArmond (U.S. Pat. No. 5,609,325) discloses a similar tool, with a sharpened V-notch at the end which contacts the tap root, and this tool is first used to loosen the ground in the vicinity of the weed, and then is used to dig up the weed by supporting the tap root from below. DeArmond's tool does not accomplish its objective in as efficient a manner as the invention disclosed in this application, which simply requires the tool to be inserted in the ground once beside the tap root, then swung in a smooth motion to dislodge the plant with its tap root.

Davison (U.S. Pat. No. 1,857,500) discloses a tool having three tines. This tool is designed for use in lawns, and the mode of use disclosed indicates that the tines are to be pushed into the root bundle, and the weed is to be levered out using the fulcrum. In musk thistles, this operation would result in the tap root being broken off just below ground level, thus providing the opportunity for more regrowth of the weed. In addition, in compacted and rocky soils, the tines may be subject to bending or breakage.

Rundle (U.S. Pat. No. 3,138,365) discloses a tool in which tines made out of sheet metal engage the tap root, or alternatively are used to loosen the earth around the tap root, and then engage the root and pull the weed from the ground. In the soils where musk thistles grow, these tines would be easily bent or broken if the tap root were engaged directly, or the tap root would be broken off at or near ground level; if the tool were first used to loosen the soil, the tines would be easily bent or broken on contact with compacted or rocky soil.

Ruffcom (U.S. Pat. No. 2,121,265) and Stecker (U.S. Pat. No. 2,504,746) both disclose hand tools which are designed for lawn and garden use. Stecker's tool is designed to cut the tap root off below ground level, and the mode of use disclosed in Ruffcorn's tool is similar to Davison's tool, in which the tines are inserted into the root and the root is levered out. In musk thistles and other such noxious weeds, this would result in the tap root being broken off just below ground level, in both cases resulting in regrowth of the weed.

Kulesh (U.S. Pat. No. 2,373,898) discloses a tool stamped from sheet metal with several bends in it, for use in lawn and garden areas on shallow-rooted weeds. This tool would be easily destroyed in compacted and rocky soils, even if it were modified to support deep tap roots from below. In addition, there is no cross-member by which it may be driven deeply enough into the soil to reach the bottom of a deep tap root, apparently being intended for shallow-rooted weeds only.

Shelkofsky (U.S. Pat. No. 1,822,675), Shurtz (U.S. Pat. No. 3,273,929) and Clarke (U.S. Pat. No. 357,907) disclose similar tools in which a chopping motion is employed to make contact with the weed at or slightly under ground level. These tools appear to be sturdily designed but they all have the common problem of not getting under the tap root of the weed and forcing it upwards, but with the chopping motion potentially severing the tap root at or under ground level. These tools are also potentially dangerous to the user, since in the course of the chopping motion the sharp tines intended to make contact with the weed are coming towards the legs and lower body of the user. Mikkelson (U.S. Pat. No. 2,166,015) discloses a somewhat similar combination tool which is designed in part to remove dandelions from lawns, and in doing so, the tool will contact the plant at or slightly beneath ground level. This may be a successful method for dandelion eradication, but it will only serve to break the plant off at ground level, especially if the plant is rooted in compacted or rocky soil.

Close (U.S. Pat. No. 5,865,348) discloses a tool in which the end of the tool which contacts the weed does so at ground level, the V-notch grips the weed, and by rocking the tool along the fulcrum, the weed is pulled from the ground. In the case of the musk thistle, the tap root would be broken off at ground level, making regrowth possible. Franz (U.S. Pat. No. 2,843,359) discloses a similar tool, at least in operation, if not in appearance, which would suffer from the same problem of breaking off the tap root at or near ground level.

Lumry (U.S. Pat. No. 1,494,557), Pederson (U.S. Pat. No. 3,288,437), Novotny (U.S. patent application Ser. No. 09/915,389) and Baker (U.S. Pat. No. 3,976,282) disclose similar inventions where tines attached to a cylindrical or curved fulcrum contact the weed at the tap root at or slightly below ground level. Baker discloses an invention in which the tap root comes into contact with a sharpened V-notch, which can sever the tap root at or near ground level, and Lumry and Pederson disclose an invention where tines are driven into the tap root and then the tool is rotated about the cylindrical or curved fulcrum lifting the weed out of the ground. For a musk thistle plant, Lumry's and Pederson's inventions would break the tap root at the point of insertion of the tines, leading to incomplete removal of the tap root and subsequent regrowth.

Kiaffert (U.S. Pat. No. 1,278,680) discloses an invention which is styled as a “weed cutter” whose working edge is sharpened and designed to cut the root of the weed at some place at or below the surface of the ground so that the remainder may be easily pulled out, leaving part of the tap root behind. Beardsley (U.S. Pat. No. 2,378,459) discloses an invention which has a V-notch which may be pushed into the ground to engage and cut the tap root below ground level, which would be sufficient to eradicate most weeds, but which would allow for musk thistles and other such noxious weeds to re-grow.

Donaldson (U.S. Pat. No. 1,908,735) discloses an invention made from stamped or forged sheet metal whose mode of use in removal of deep-rooted weeds is to make two or more cuts on opposite sides of the weed, so that the resulting divot may be levered out, the weed removed by hand, and the divot replaced. This invention is directed towards removal of dandelions from lawns, and owing to its construction and mode of use might not be sturdy enough to remove plants from compacted or rocky soil.

Smith (U.S. Pat. No. 1,864,373) and Maxcy (U.S. Pat. No. 2,247,958) disclose similar tools. Smith's tool employs a fork to grip the tap root; if the tap root of a musk thistle is pierced, it is easily broken off. Smith's invention does not also supply any springing motion to push the weed out of the ground, but uses the fork to grab the tap root and pull the weed. The fork as pictured is also unlikely to stand up under rough usage as might be expected from an agricultural user. Maxcy's tool uses a sharpened sheet metal trowel, upon which has been welded a thin triangular piece of sheet metal, and is designed to be used in lawns and gardens. Maxcy's tool is not designed to be used in compacted or rocky soils which would bend or otherwise deform and break the thin metal used in the tool and dull the blades. This tool would support the plant from below but would likely deform when forced through compacted or rocky soils in the course of use.

Ruddy (U.S. Pat. No. 1,107,705) discloses a tool in which two metallic fingers are pushed down into the ground straddling the tap root of a weed but do not otherwise support it and the tool is rotated around a fulcrum crossbar between the two fingers and perpendicular to them presumably pulling the weed from the ground. On a musk thistle plant, where the tap root is prone to breakage, this tool would break the tap root off at the crown if it had any effect at all. This tool appears to be designed for use with shallow rooted weeds which have a dense root bundle at or near the surface.

Finally, Hoover (U.S. patent application Ser. No. 10/717,724) discloses a hoe which grabs the weed at ground level and in the case of plants having deep and strong tap roots, the plant is successfully removed. Musk thistle tap roots would break off at the point of connection, allowing for regrowth of the plant, rendering the tool disclosed in Hoover unsuitable for the task of removing musk thistles and similar noxious weeds with tap roots which tend to break easily.

### SUMMARY OF THE INVENTION

(1) New and Different Function

This invention relates to the extraction of plants from the ground, and more particularly, to a plant cultivation tool having a curved blade made of spring steel which will provide a springingols designed for use in soft and moist soils such as are found in lawns and gardens. This tool is designed for use in areas where the appearance of the ground after the weed is extracted is not important, unlike tools to be used in lawn weeding motion to aid in dislodging a plant from the ground with its taproot intact. This invention also relates to the loosening of rocky, sandy, or compacted soils, and to the placement of plants in soils.

This tool is especially directed towards the extraction of musk thistle plants and other plants from both cultivated soils and grasslands where the soil may be compacted, and contain rocks and sand. This tool is constructed out of materials such as spring steel, steel pipe, and angle iron, which will survive rough treatment, unlike the great majority of to, where appearance after removal of weeds is of paramount importance.

Removal of musk thistle plants from farm properties is mandated by law in many states, on grounds that the plant is a noxious weed which spreads with great speed and crowds out crops. There is great vigilance exercised in the enforcement of these laws, with fines being levied and the possibility of jail time for repeat offenders who fail to remove all of the musk thistles from their property. In the recent past, most musk thistle control has been accomplished through the use of herbicides, but with the increased incidence of organic farming, a way of eradicating musk thistles which does not use herbicides is in great demand amongst farmers.

In order to eradicate an infestation of musk thistles, the plants must be removed with tap roots intact, and this removal must occur before the top part of the thistle turns purple and releases its seeds. If the tap root is severed, or if any part of it is left in the ground, the plant will grow back, often with four or five new stalks replacing the one which has been removed. This plant grows in compacted and sandy soils, which are difficult to penetrate using conventional tools, and the tap root is easily severed or broken off.

For successful removal, the tap root must be supported from below, and motive force must be applied upward on the tap root, forcing the plant upward and out of the ground. The tap root is supported by the “cloverleaf” fingers at the working end of the tool, and the motive force is generated by swinging the handle of the tool towards the ground in a swift smooth motion, which in hard compacted soil may partially compress the spring steel blade which if correctly inserted alongside the plant moves the “cloverleaf” fingers at the working end of the blade under the tap root. The spring steel blade returns to its former conformation, the rigid curved spring steel blade moves and in so doing the “cloverleaf” fingers force the musk thistle plant out of the ground with its tap root intact, “popping” the plant out of the ground. A similar operation serves to break up and loosen rocky, sandy, or compacted soils.

(2) Objects of this Invention

The primary object of the invention is efficiency in removing musk thistle plants and other such plants, with the tap root intact, from compacted soils which may be sandy or rocky as well. The great majority of the related art found is directed towards the removal of lawn and garden weeds, such as dandelions and plantains, from cultivated and well broken up soils such as are found in lawns and gardens. Very few of the inventions encountered are directed towards farm use, and no invention was found which had its object the efficient and complete mechanical removal of musk thistle plants from any types of soil in which this plant is commonly found.

Further objects of this invention are to provide a sturdy and durable tool which will survive years of rough use, in rocky, sandy, and compacted soils, and which will perform its task in a manner ecologically compatible with organic farming, in which the use of herbicides may be prohibited by law, if not proscribed by common practice, yet is inexpensive to manufacture (and may be manufactured from recycled materials) and is easy and cheap to maintain in proper working order.

More objects of this invention are to provide a sturdy and durable tool which can be used to prepare compacted, rocky, or sandy soils for planting, from plants such as trees and shrubs, to potted plants, and to assist in the placement of those plants in the soil.

Other objects of this invention are to achieve the goal of removing musk thistle plants and other such noxious weeds with a method that is versatile, ecologically compatible, energy conserving, rapid, efficient and inexpensive and which does not require skilled labor to operate; and to provide a versatile tool which may be used for many other tasks encountered in the course of operating a farm.

### BRIEF DESCRIPTION OF THE DRAWINGS

It is believed that the embodiment of the invention will be better understood from the following description, taken in conjunction with the accompanying drawings, wherein:

FIG. 1 is a side elevation of a plant cultivation tool which can be used to eject plants from the ground;

FIG. 2 is a front elevation of the tool illustrated in FIG. 1;

FIG. 3 is a back elevation of the tool illustrated in FIG. 1;

FIG. 4 is a transverse view of the tool illustrated in FIG. 1;

FIG. 5 is a front elevation showing the “cloverleaf” blade edge of the tool in FIG. 1;

FIG. 6 is a transverse view of the “cloverleaf” blade edge illustrated in FIG. 5;

FIG. 7 is an illustration of a person inserting the blade of the tool illustrated in FIG. 1 into the ground using the step member of the plant cultivation tool; and

FIG. 8 is an illustration of a person ejecting the plant from the ground with tap root intact after moving the handle of the tool illustrated in FIG. 1 downward in a smooth quick manner.

### DESCRIPTION

Overview

The invention described herein provides an apparatus for the ejection of plants from the ground with tap root intact, and the subsequent removal thereof, for loosening and breaking up rocky, sandy, or compacted soils, and for assistance in placing plants in the soil.

Detailed Description of the Elements of the Invention

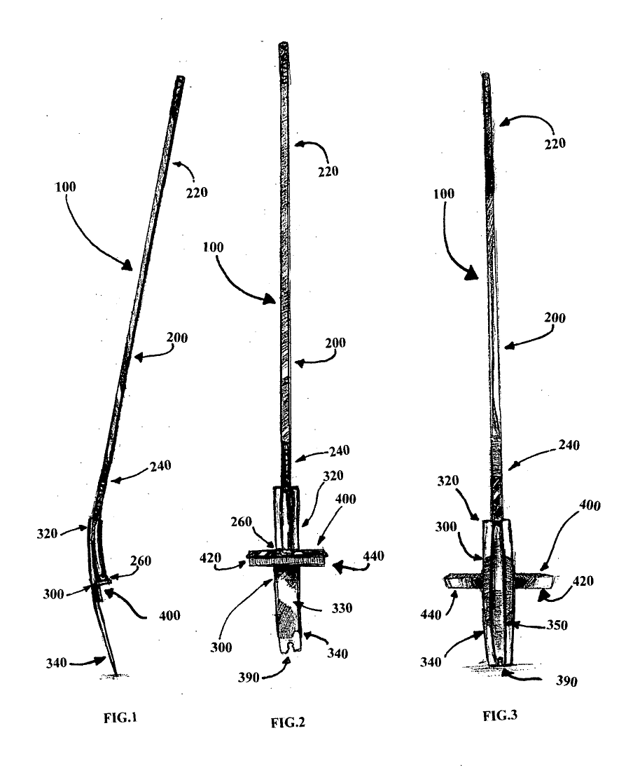

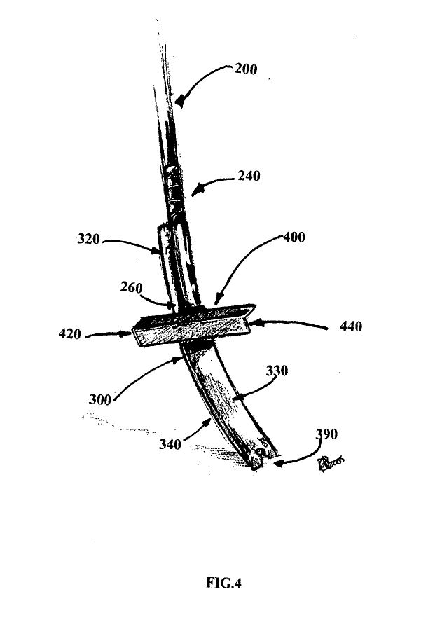

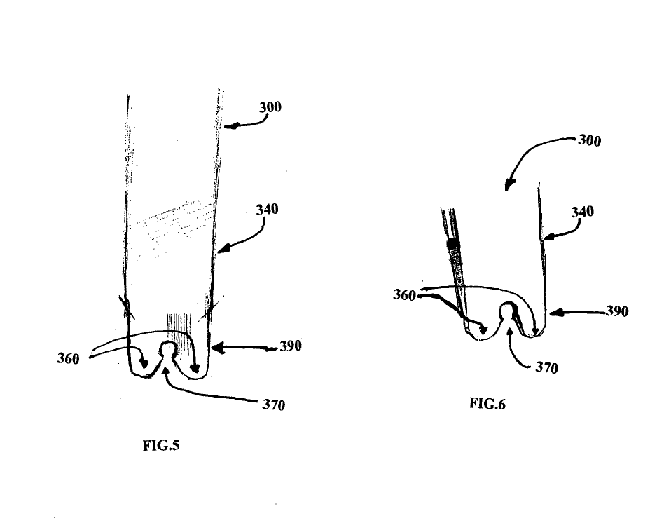

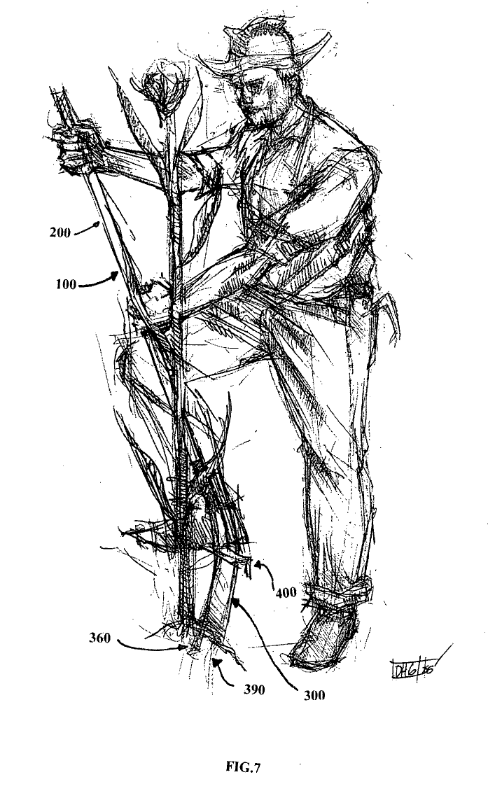

Referring to FIGS. 1-6, a plant cultivation tool 100 includes a handle 200 having a first end 220 and a second end 240 and a tip 260. The first end 220 of the handle 200 may be grasped by a person for manipulation of the plant cultivation tool 100. The handle 200 may be constructed of steel or other metal which is resistant to bending or deformation on the application of force to the handle 200 for providing a sturdy and durable hand grip component of the plant cultivation tool 100. The handle 200 is sized such that a person may utilize the plant cultivation tool 100 in a standing position.

A curved blade member 300 having a first end 320 and a front side 330 and a second end 340 and a back side 350 is attached to the second end 240 of the handle 200. The curved blade member 300 is curved so that the back side 350 is convex and the front side 330 is concave. The curved blade member 300 may be formed from SAE 5160 spring steel or material having similar metallurgical properties or composition or some other durable material. The curved blade member 300 has a thickness which may be between 0.250 inch and 0.500 inch on the first end 320 and tapering on the back side 350 to a thickness which may be between 0.063 inch to 0.250 inch on the second end 340. The curved blade member 300 may be 2.5 inches in width and may be 18 to 24 inches in length. The curved blade member 300 may also have an indentation of 0.125 inch depth on the back side 350 of the curved blade member 300 which may extend lengthwise from the first end 320 to the second end 340 of the curved blade member 300 between 18 inches to 24 inches and may extend between 0.300 inches to 0.400 inches on each side of the midpoint of the width of the curved blade member 300. The second end 240 of the handle 200 is bent in a fashion which will accommodate and conform to the curvature of the curved blade member 300 so that the second end 240 of the handle 200 may be continuously welded or otherwise attached to the front side 330 of the first end 320 of the curved blade member 300. The portion of the second end 240 of the handle 200 which is bent in this fashion may extend for 6 to 8 inches from the tip 260 of the second end 240 of the handle 200. The second end 320 of the curved blade member 300 contains a tapered blade working edge 360 at the midpoint of which is located a keyhole notch 370 which may be located 2 inches to 4 inches from the tapered blade working edge 360 at the second end 320 of the curved blade member 300. The tapered blade working edge 360 and the keyhole notch 370 together comprise a “cloverleaf” member 390. The spring steel of which the curved blade member 300 may be composed imparts a springing action to effectuate removal of the plant, or to break through rocky, sandy, or comapcted soils, and the cloverleaf member 390 supports but does not grab or otherwise cut or sever or penetrate the tap root of the plant when total removal of a plant is desired.

A step member 400 is attached to the tip 260 of the second end 240 of the handle 200 and to the first end 320 of the curved blade member 300. The step member 400 is a cross-bar or angle iron attached horizontally to the handle 200 at approximately its midpoint for providing a first step portion 420 and a second step portion 440 extending from opposite sides of the handle 200. This step member 400 is attached by continuous welding or other suitable means to the tip 260 of the second end 240 of the handle 200 and to the front side 330 of the curved blade member 300. A person may step on or otherwise apply pressure or force to the step member 400 for forcing the tapered blade working edge 360 and the curved blade member 300 of the plant cultivation tool 100 into the ground.

Mode of Use of the Invention

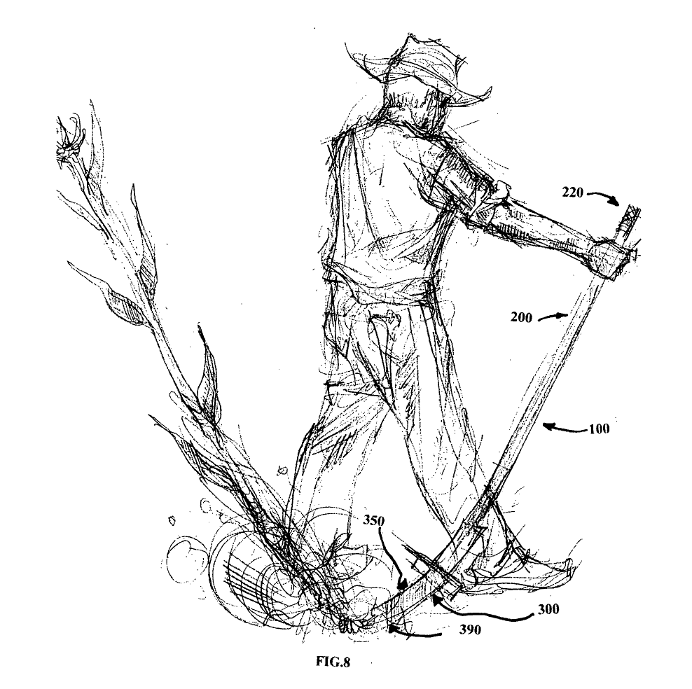

Referring to FIGS. 7-8, in operation, a person positions the plant cultivation tool 100 adjacent to a plant, in FIGS. 7-8 a musk thistle plant, and steps on the step member 400 for insertion of the tapered blade working edge 360 and its associated “cloverleaf” member 390 and the second end 340 of the curved blade member 300 of the plant cultivation tool 100 into the ground adjacent to the plant. By moving the handle 200 in a smooth continuous arcuate motion towards the ground, the “cloverleaf” member 390 is forced under the taproot of the plant, and motive force upward on the tap root is supplied by the upward motion of the curved blade member 300 created by the downward motion of the handle 200 using the step member 400 as a fulcrum, thereby forcing the plant with tap root intact out of the ground. The back side 350 of the curved blade member 300 of the plant cultivation tool 100 is then kicked by the user which completely removes the plant from the tool.

In the operation of loosening and breaking up rocky, sandy, or compacted soil, the series of operations above are carried out, except there is no plant or taproot present. The tapered blade working edges 360 of the plant cultivation tool 100 are driven into the soil using the step member 400, and motive force upward on the soil above the curved blade member 300 is supplied by the upward motion of the curved blade member 300 created by the downward motion of the handle 200 using the step member 400 as a fulcrum, thus breaking the soil. These operations are repeated until the desired degree of soil loosening is achieved.

In the operation of assisting placement of plants into the soil, the taproot of the plant is inserted into the keyhole notch 370 adjacent to the tapered blade working edges 360 on the second end 340 of the curved blade member 300 of the plant cultivation tool 100. The taproot is supported by the keyhole notch 370 and the curved blade member 300 and the stem is supported by the user with one hand, who inserts the tool into a previously dug hole with the other hand. The tapered blade working edges 360 are used to seat the taproot into the soil, and the tool is removed from the soil while the user continues to support the stem of the plant. The user then fills and tamps the hole with dirt sufficient to support the plant in a proper orientation.

Advantages of the Invention

The aforementioned embodiments of this invention have many advantages over related art, including, but not limited to, the following:

1. A tool is provided for the complete removal of a plant, especially a musk thistle plant, and its tap root, without the risk of breaking the tap root and thus leaving portions in the ground which could result in regrowth of the weed.

2. The tool is sturdily built, so that it may be used in rocky or compacted dry soils without risk of breaking or deforming, and so that the working edge may be driven into the ground with human or mechanical means.

3. Once the tool has been driven into the ground beside the taproot of the plant, it is easily and efficiently operated, by means of an easy throw of the tool handle, to eject the plant with taproot intact from the ground. This occurs because the handle is made of heavy steel, which serves to concentrate force at the working edge of the tool below the fulcrum provided by the cross-member which also serves as a step for driving the tool into the ground beside the taproot of the plant

4. The tool can also serve to break up rocky, sandy, or compacted soils to sufficient degree to permit cultivation of those soils, and it can serve to create holes for placing plants in the prepared soils. Finally, the tool can be used to firmly seat the taproot in the soil using the tapered blade working edges adjacent to the keyhole notch to drive the tool and plant deeper into the soil, when it is desired to place plants in soil.

A Prospective Specific Embodiment of the Invention

As one example, the overall length of the plant cultivation tool 100 may be approximately 60 inches to reduce the amount of bending that a person may need to do during operation of the plant cultivation tool 100 and to increase the upward motive force applied to the plant taproot by the “cloverleaf” member 390 when the handle 200 is moved in a smooth continuous arcuate motion towards the ground using step member 400 as a fulcrum. The handle 200 may be approximately 48 inches long and approximately 1 inch in diameter. The curved blade member 300 may be formed from SAE 5160 spring steel. The curved blade member 300 may be approximately 18.5 inches long and approximately 2.5 inches wide and having approximately 6.75 inches of its length welded to the handle 200 and having approximately 1.25 inches of its length welded to the step member 400, and having approximately 10.5 inches of its length extending below the step member 400. The curved blade member 300 may be approximately 0.250 inches thick for approximately 15.75 inches of its length measuring from the first end 320 of the curved blade member 300 and extending toward the second end 340 of the curved blade member 300, and the curved blade member 300 may taper from approximately 0.250 inches thick at approximately 15.75 inches of its length to approximately 0.125 inches thick at approximately 17.75 inches of its length, measuring from the first end 320 of the curved blade member 300 and extending toward the second end 340 of the curved blade member 300, and then the curved blade member 300 may taper from 0.125 inches thick at approximately 17.75 inches of its length to approximately 0.05 inches thick at approximately 18.5 inches of its length, measuring from the first end 320 of the curved blade member 300 and extending toward the second end 340 of the curved blade member 300. The width of the tapered blade working edges 360 forming the “cloverleaf” member 390 may be approximately 0.833 inches each, and the width of the mouth of the keyhole notch 370 may be approximately 0.833 inches, and the width of the throat of the keyhole notch 370 may be approximately 0.375 inches, and the diameter of the circular opening connected to the throat of the keyhole notch 370 may be approximately 0.500 inches and the depth of the keyhole notch 370 may be approximately 1.25 inches measuring from the tapered blade working edge 360 of the second end 340 of the curved blade member 300 towards the first end 320 of the curved blade member 300 of the plant cultivation tool 100. The ends of the tapered blade working edges 360 which are components of the “cloverleaf” member 390 may be semicircular in profile. The step member 400 may be a strip of angle iron 1.25 inches in width on each side where the two sides are joined to each other lengthwise at a 90 degree angle and the total length of said step member 400 may be approximately 9 inches, approximately 4.5 inches extending on either side of the midpoint of the curved blade member 300 to which the step member 400 is attached.

Although the present invention has been described in considerable detail with reference to certain preferred embodiments thereof, other embodiments are possible. For example, the step member 400 may be composed of a cross-member other than an angle iron and instead have a circular, oval, square, or rectangular cross-section. Also, the curved blade member 300 may have a different length, width, or degree of curvature, and may be fabricated from different kinds of metal or other material, and the step member 400 may be attached to the curved blade member 300 at different distances from the tapered blade working edges 360. The first end 220 of the handle 200 may have indentations, engraved marks, or other mechanical alterations so that the tool 100 may be more easily grasped by the user. Alternatively, a handgrip made from metal, plastic, textile, or some other material could be attached to the first end 220 of the handle 200 so that the plant cultivation tool 100 may be more easily grasped by the user. Also, the keyhole notch 370 and the tapered blade working edges 360 which comprise the “cloverleaf” member 390 may have differing configurations: the keyhole notch 370 may be triangular, rectangular, square, oval, or have some other shape, and the tapered blade working edges 360 may vary from semicircular to flat to elongated ellipsoidal configurations. Therefore, the spirit and scope of the appended claims should not be limited to the descriptions of the preferred embodiments contained herein.

I claim:

1. A plant cultivation tool comprising:
(a) a handle member comprising a rod with a first end and a second end;
(b) a blade member comprising a plate with a first end and a second end and a front side and a back side, attached to the second end of the handle member by welding, bolt, screw, rivet, or fastener;
(c) a step means, attached to the second end of the handle member by welding, bolt, screw, rivet, or fastener, and also attached to the first end of the blade member by welding, bolt, screw, rivet, or fastener, for driving the tool into the ground and for also serving as a fulcrum about which the handle may rotate downward towards the ground thus driving the blade upward and forcing the plant taproot out of the ground.

2. The plant cultivation tool in claim 1 where the rod comprising the handle member has a circular cross section.

3. The plant cultivation tool in claim 1 where the rod comprising the handle member has an annular cross section.

4. The plant cultivation tool in claim 1 where the rod comprising the handle member has a rectangular cross section.

5. The plant cultivation tool in claim 1 where the blade member is rectangular in shape, where the width of the blade member is less than the length of the blade member, and where the thickness of the blade member is less than the width of the blade member.

6. The plant cultivation tool in claim 5 where the blade member has a groove running along the length of the blade member on its back side, centered about the midpoint of the width of the blade member.

7. The plant cultivation tool in claim 6 where the groove has semicircular cross-section.

8. The plant cultivation tool in claim 6 where the groove has rectangular cross-section.

9. The plant cultivation tool in claim 6 where the groove has a cross-section in the shape of a “V”.

10. The plant cultivation tool in claim 6 where the groove has a cross-section intermediate between any of the shapes enumerated in claims 7, 8, or 9.

11. The plant cultivation tool in claim 5 where the blade member is fabricated from spring steel.

12. The plant cultivation tool in claim 5 where the blade member is fabricated from other durable materials including plastic or ceramic compositions.

13. The plant cultivation tool in claim 6 where the blade member is fabricated from SAE 5160 spring steel.

14. The plant cultivation tool in claim 6 where the blade member is fabricated from material having similar metallurgical properties or composition.

15. The plant cultivation tool in claim 6 where the blade member is curved along its long axis so that the front side is concave and the back side is convex.

16. The plant cultivation tool in claim 6 where the blade member is curved along its short axis so that the front side is concave and the back side is convex.

17. The plant cultivation tool in claim 6 where the blade member is curved along its long and short axes so that the front side is concave and the back side is convex.

18. The plant cultivation tool in claim 15 where the blade member has a taper on the back side which runs from the original thickness of the plate to a pointed tip at the second end.

19. The plant cultivation tool in claim 18 where the taper begins at any point between the first end of the blade member and the second end of the blade member.

20. The plant cultivation tool in claim 19 where there is a notch in the shape of a “V” arranged symmetrically about the midpoint of the width of the second end of the blade member.

21. The plant cultivation tool in claim 20 where there is a circular opening whose midpoint is the apex of the “V” notch arranged symmetrically about the midpoint of the width of the second end of the blade member.

22. The plant cultivation tool in claim 21 where the diameter of the circular opening is equal to the width of the groove in claim 6, and where the circular opening is arranged symmetrically about the midline of said groove.

23. The plant cultivation tool in claim 20 where the two tips of the second end on either end of the said “V” notch are square.

24. The plant cultivation tool in claim 20 where the two tips of the second end on either end of the said “V” notch are semicircular.

25. The plant cultivation tool in claim 20 where the two tips of the second end on either end of the said “V” notch are half-oval.

26. The plant cultivation tool in claim 24 where the two semicircular tips of the second end on either end of the said “V” notch are beveled in a semicircular fashion.

27. The plant cultivation tool in claim 1 where the step member is comprised of angle iron with an “L” cross-section.

28. The plant cultivation tool in claim 1 where the step member is comprised of a rod with a circular cross-section.

29. The plant cultivation tool in claim 1 where the step member is comprised of a rod with an annular cross-section.

30. The plant cultivation tool in claim 1 where the step member is comprised of a rod with a rectangular cross-section.

31. The plant cultivation tool in claim 1 where the handle member is fabricated from tool steel or other metal which is resistant to bending or deformation on the application of force to the handle member.

32. The plant cultivation tool in claim 1 where the step member is fabricated from tool steel or other metal which is resistant to bending or deformation on the application of force to the step member.

33. A method for extracting a plant from the soil, which comprises:
(a) placing the plant cultivation tool adjacent to but not touching the plant;
(b) driving the tapered blade working edges into the soil using the step member;
(c) throwing the handle in a smooth continuous arcuate motion downward towards the ground; and
(d) kicking the step member to remove the plant from the tool.

34. A method for loosening rocky, sandy, or compacted soils, which comprises:
(a) placing the plant cultivation tool on the ground;
(b) driving the tapered blade working edges into the soil using the step member;
(c) moving the handle in a smooth continuous arcuate motion towards the ground, with sufficient force to break the soil; and
(d) repeating steps (a), (b), and (c) until the desired extent and degree of soil loosening is achieved.

35. A method for placing plants into the soil, which comprises:
(a) placing the taproot of the plant into the keyhole notch adjacent to the tapered blade working edges;
(b) guiding the taproot into a previously dug hole, with the blade supporting the taproot and the upper part of the plant supported by the user;
(c) using the tapered blade working edge to seat the taproot deeper in the hole;
(d) removing the tool from the hole while supporting the stem of the plant; and
(e) filling the hole with dirt so that the plant is properly supported.
